(19) United States
(12) Patent Application Publication
(10) Pub. No.: US 2024/0326903 A1
(43) Pub. Date: Oct. 3, 2024

(54) HYDRAULIC STEERING ARRANGEMENT

(71) Applicant: Danfoss Power Solutions ApS, Nordborg (DK)

(72) Inventor: Abdul Karim Rahimzai, Sonderborg (DK)

(21) Appl. No.: 18/609,317

(22) Filed: Mar. 19, 2024

(30) Foreign Application Priority Data
Mar. 31, 2023 (DE) 10 2023 108 099.7

(51) Int. Cl. B62D 5/065; B62D 5/06; B62D 5/087

(52) U.S. Cl. CPC B62D 5/065; B62D 5/062; B62D 5/087

(57) ABSTRACT

A hydraulic steering arrangement (1) including a supply port arrangement having a supply port (2) and a return port (3), a working port arrangement having two working ports (4, 5), a supply flow path (7) between the supply port (2) and one of the working ports (4, 5), a return flow path (9) between the other of the working ports (5, 4) and the return port (3) and a valve arrangement having a spool/sleeve set, wherein the supply flow path (7) includes a supply orifice (A₄) and the return flow path (9) comprises a return orifice (A₅). Such a hydraulic steering arrangement should give a comfortable feeling when used in connection with an articulated vehicle. To this end a variable damping orifice (A_{dp}) is arranged downstream the supply orifice (A₄) and upstream the return orifice (A₅).

### CROSS-REFERENCE TO RELATED APPLICATION

This application claims foreign priority benefits under 35 U.S.C. § 119 from German Patent Application No. 10 2023 108 099.7, filed Mar. 31, 2023, the content of which is hereby incorporated by reference in its entirety.

### TECHNICAL FIELD

The present invention relates to a hydraulic steering arrangement comprising a supply port arrangement having a supply port and a return port, a working port arrangement having two working ports, a supply flow path between the supply port and one of the working ports, a return flow path between the other of the working ports and the return ports, and a valve arrangement having a spool/sleeve set, wherein the supply flow path comprises a supply orifice and the return flow path comprises a return orifice.

### BACKGROUND

When such a hydraulic steering arrangement is used to steer a vehicle, hydraulic fluid is supplied from the supply port via the main flow path to one of the working ports and from there to a steering motor. Hydraulic fluid displaced from the hydraulic steering motor is returned via the other working port and the return line back to the return port. The direction of steering is determined by means of the valve arrangement. The valve arrangement in turn can be controlled, for example, by the movement of a steering wheel.

When such a steering arrangement is used with an articulated vehicle, not only steered wheels are moved, but an angle between parts of the vehicle is changed. Thus, large masses have to be moved. This causes a problem, since these large masses have to be accelerated at the start of the steering and decelerated at the end of the steering.

In an articulated vehicle it can be observed that oscillations occur during steering. These oscillations are prominent at the start of the steering and at the end of the steering. Each change in direction will cause a jerk, and this will be repeated with less and less magnitude until there is no potential energy left. Such a jerk is uncomfortable for a driver.

### SUMMARY

The object underlying the invention is to make steering of an articulated vehicle comfortable.

This object is solved with a hydraulic steering arrangement as described at the outset in that a variable damping orifice is arranged downstream the supply orifice and upstream the return orifice.

The terms “downstream” and “upstream” relate to the flow of the hydraulic fluid during steering. In other words, the hydraulic fluid flows through the supply orifice before reaching one of the two working ports and is returned to the other of the two working ports before reaching the return orifice. The damping orifice is thus arranged after the supply orifice and before the return orifice. In a simple way it can be said that the variable damping orifice is arranged between the two working ports, although other solutions are possible.

The variable damping orifice can reduce the intensity of flow rate of the hydraulic fluid supplied to the steering motor via the working port at abrupt steering start as part of the flow of the hydraulic fluid is directed just to the other side of the steering motor or just upstream or before the return orifice. Thus, the impulse and inertia force affecting the steering motor can be reduced. In addition, as part of the forward flow is directed to the other side of the steering motor or just upstream the return orifice, the pressure at the return side of the steering motor will increase which counteracts the inertia forces from the other side of the steering motor. A similar effect can be observed when steering stops. When steering stops, the steering motor will still move to the previously commanded direction due to inertia forces. By having the damping orifice between the two working ports or downstream the supply orifice and upstream the return orifice it will reduce the pressure in the forward side of the steering motor and increase it at the return side of the steering motor during the time when steering is stopped, and the spool/sleeve set is returning to its neutral position. This will also reduce the intensity of the jerk. Furthermore, it is ensured that the same flow of hydraulic fluid flowing through the supply orifice flows the return orifice regardless whether this flow back is fluid displaced from the steering motor or fluid which has passed the damping orifice. Thus, the parameters for the pressure drop over the return orifice are not changed compared with a situation without damping orifice. The back pressure, i.e. the pressure at the return working port, can be kept at a suitable level.

In an embodiment of the invention the variable damping orifice is closed in neutral position of the spool/sleeve set. In the neutral position of the spool/sleeve set there should be no movement of the steering motor. When the variable damping orifice is closed, there is no possibility for the hydraulic fluid to flow from one port of the steering motor to the other port of the steering motor. The steering motor is held clamped or trapped when the spool/sleeve set is in neutral position.

In an embodiment of the invention the variable damping orifice is closed at a maximum deflection of the spool/sleeve set. In the maximum deflection of the spool/sleeve set the flow of hydraulic fluid to one of the working ports is at a maximum and the steering motor should be operated with the highest operating speed possible. In this situation it is of advantage that no fluid can flow to the other side of the steering motor which would decrease the steering speed. The purpose of the damping bleed being closed at maximum deflection is to prevent slip at the “end-position” (when the cylinder is at the end position it should not be possible to turn to steering wheel of the vehicle further).

In an embodiment of the invention the variable damping orifice opens at a deflection of the spool/sleeve set which is larger than a deflection of the spool/sleeve set at which the supply orifice and/or the return orifice opens. Thus, there is an initial supply of hydraulic fluid to the steering motor before the variable damping orifice opens.

In an embodiment of the invention the variable damping orifice is formed by the spool/sleeve set. The spool/sleeve set already forms several orifices which are used to control the amount and direction of the flow of hydraulic fluid from the supply port to one of the working ports. It is possible to modify the spool/sleeve set in a way that the variable damping orifice can also be arranged in the spool/sleeve set. This has the additional advantage that no additional measures must be taken to open and close the variable damping orifice depending on the deflection of the spool/sleeve set.

In an embodiment of the invention an amplification flow path is arranged in parallel to the main flow path, wherein the amplification flow path opens into the main flow path upstream the damping orifice. This means that also the hydraulic fluid supplied via the amplification flow path is treated in the same way as the flow of hydraulic fluid flowing through the main flow path.

In an embodiment of the invention the amplification flow path opens into the main flow path upstream the supply orifice. This means that the supply orifice also controls the flow of hydraulic fluid from the amplification flow path.

### BRIEF DESCRIPTION OF THE DRAWINGS

An embodiment of the invention will now be described with reference to the drawing, in which:

FIG. 1 schematically shows a hydraulic steering arrangement and

FIG. 2 schematically shows opening degrees of several orifices shown in FIG. 1.

### DETAILED DESCRIPTION

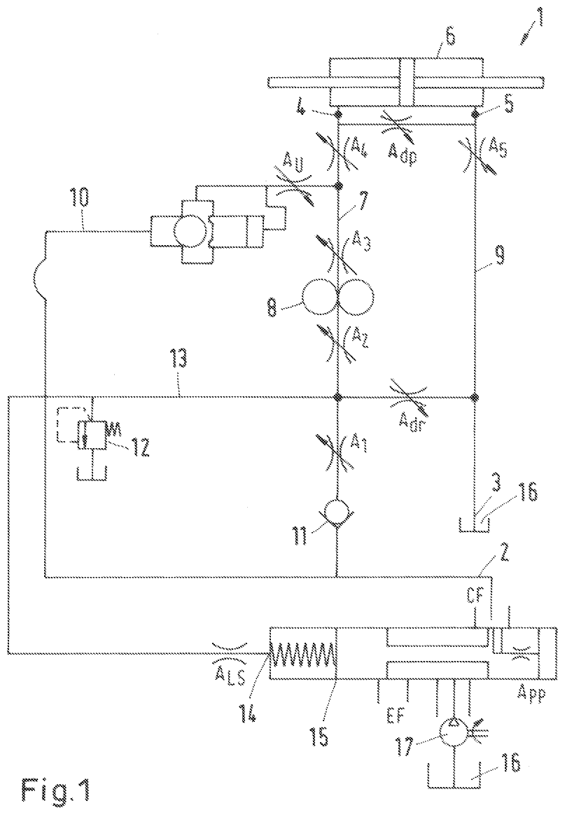

FIG. 1 schematically shows a hydraulic steering arrangement 1 having a supply port arrangement, known for example from DE102018125053. The supply port arrangement comprises a supply port 2 and a return port 3. Furthermore, two working ports 4, 5 are provided, wherein the working ports 4, 5 form a working port arrangement. A steering motor 6 is connected to the working ports 4, 5.

The steering arrangement 1 comprises a main flow path 7 which comprises a main orifice A₁ and a measuring motor 8. A first measuring motor orifice A₂ is arranged upstream the measuring motor 8 and a second measuring motor orifice A₃ is arranged downstream the measuring motor 8. The terms “upstream” and “downstream” relate to the direction of the flow through the main flow path 7 and the measuring motor 8. The main flow path 7 is connected to one of the working ports 4 via a supply orifice A₄. The other working port 5 is connected to a return flow path 9 via a return orifice A₅.

The orifices A₁, A₂, A₃, A₄, and A₅ are part of a valve arrangement which is formed by a spool/sleeve set as it is known in the art. The valve arrangement determines which of the two working ports 4, 5 is connected to the main flow path 7 and which of the working ports 5, 4 is connected to the return flow path 9.

The hydraulic steering arrangement 1 can also comprise an amplification flow path 10 which is connected to the supply port 2 and opens into the main flow path 7 between the supply orifice A₄ and the second measuring motor orifice A₃. The amplification flow path 10 comprises an amplification orifice AU which is also formed in the spool/sleeve set of the valve arrangement and controlled in a way similar, but not necessarily identically to the control of the main orifice A₁.

In the present steering arrangement 1 a drain orifice A_{dr} is arranged between the main flow path 7 and the return flow path 9, more precisely between a point between the main orifice A₁ and the first measuring motor orifice A₂ and the return flow path 9.

A check valve 11 is arranged upstream the main orifice A₁ and opens in direction towards the main orifice A₁.

The main flow path 7 is connected to a relief valve 12 which branches of a line 13 connecting the main flow path 7 downstream the main orifice A₁ to a load sensing port 14 of a priority valve 15. The priority valve 15 controls a supply of hydraulic fluid from a tank 16 to the supply port 2. The hydraulic fluid is pumped by means of a pump 17.

Since the arrangement and construction of the priority valve 15 is known in the art, it is not further described. The same applies for the valve 12 and the over pressure valves which normally would be placed/in connection with the working ports 4,5.

A variable damping orifice A_{dp} is arranged downstream the supply orifice A4 and upstream the return orifice A₅. The terms “downstream” and “upstream” relate to the flow of hydraulic fluid towards and from the steering motor 6. In the present case, the damping orifice A_{dp} connects the main fluid path 7 and the return fluid path 9 between the supply orifice A₄ and one of the working ports 4 on the one hand and between the other working port 5 and the return orifice A₅ on the other side.

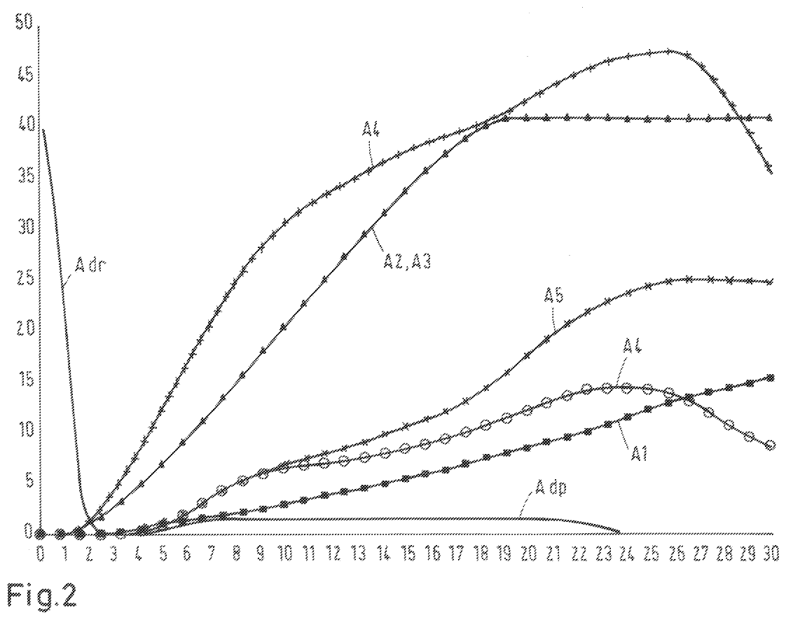

The damping orifice A_{dp} is a variable orifice which is closed in neutral position of the spool/sleeve set. Furthermore, the variable damping orifice A_{dp} is closed at a maximum deflection of the spool/sleeve set. This is schematically shown in FIG. 2.

The spool/sleeve set comprises a spool and a sleeve, wherein the sleeve surrounds the spool and is arranged in a bore of a housing. The spool and the sleeve are rotatably with respect to each other. One of spool and sleeve is connected to a steering command device, for example, a steering wheel. The other of spool and sleeve is connected to a part of the measuring motor. When the steering wheel (or any other steering command device) is rotated, the deflection between the spool and the sleeve is changed. This change opens some orifices, as shown in FIG. 2, and closes others.

In FIG. 2 the deflection is shown on the horizontal axis and the opening degree of the orifices is shown on the vertical axis. In the present embodiment, the drain orifice A_{dr} is closed at the beginning of the deflection, wherein the main orifice A₁, the amplification orifice AU, the supply orifice A₄, the return orifice A₅ and the two measuring motor orifices A₂, A₃ are opened. Hydraulic fluid flowing to a working port through the supply orifice A₄ flows through the measuring motor 8 and drives it. The measuring motor 8 restores the angular position or deflection between the spool and the sleeve to neutral, so that the drain orifice A_{dr} is opened, and the other orifices are closed.

As it is shown in FIG. 2, the damping orifice A_{dp} opens at a deflection which is larger than a deflection at which the main orifice A₁ and the amplification orifice AU opens. Furthermore, the opening degree of the damping orifice A_{dp} is nearly constant over a large range of the deflection angle. The damping orifice A_{dp} still forms a throttle resistance, i.e. the opening area of the damping orifice A_{dp} is always smaller than the opening area of the main orifice A₁ and of the amplification orifice AU.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A hydraulic steering arrangement comprising a supply port arrangement having a supply port and a return port, a working port arrangement having two working ports, a supply flow path between the supply port and one of the working ports, a return flow path between the other of the working ports and the return port, and a valve arrangement having a spool/sleeve set, wherein the supply flow path comprises a supply orifice and the return flow path comprises a return orifice, wherein a variable damping orifice is arranged downstream the supply orifice and upstream the return orifice.

2. The hydraulic steering arrangement according to claim 1, wherein the variable damping orifice is closed in neutral position of the spool/sleeve set.

3. The hydraulic steering arrangement according to claim 1, wherein the variable damping orifice is closed at a maximum deflection of the spool/sleeve set.

4. The hydraulic steering arrangement according to claim 1, wherein the variable damping orifice opens at a deflection of the spool/sleeve set which is larger than a deflection of the spool/sleeve set at which the supply orifice and/or the return orifice open.

5. The hydraulic steering arrangement according to claim 1, wherein the variable damping orifice is formed by the spool/sleeve set.

6. The hydraulic steering arrangement according to claim 1, wherein an amplification flow path is arranged in parallel to the main flow path, wherein the amplification flow path opens into the main flow path upstream the damping orifice.

7. The hydraulic steering arrangement according to claim 6, wherein the amplification flow path opens into the main flow path upstream the supply orifice.

8. The hydraulic steering arrangement according to claim 2, wherein the variable damping orifice is closed at a maximum deflection of the spool/sleeve set.

9. The hydraulic steering arrangement according to claim 2, wherein the variable damping orifice opens at a deflection of the spool/sleeve set which is larger than a deflection of the spool/sleeve set at which the supply orifice and/or the return orifice open.

10. The hydraulic steering arrangement according to claim 3, wherein the variable damping orifice opens at a deflection of the spool/sleeve set which is larger than a deflection of the spool/sleeve set at which the supply orifice and/or the return orifice open.

11. The hydraulic steering arrangement according to claim 2, wherein the variable damping orifice is formed by the spool/sleeve set.

12. The hydraulic steering arrangement according to claim 3, wherein the variable damping orifice is formed by the spool/sleeve set.

13. The hydraulic steering arrangement according to claim 4, wherein the variable damping orifice is formed by the spool/sleeve set.

14. The hydraulic steering arrangement according to claim 2, wherein an amplification flow path is arranged in parallel to the main flow path, wherein the amplification flow path opens into the main flow path upstream the damping orifice.

15. The hydraulic steering arrangement according to claim 3, wherein an amplification flow path is arranged in parallel to the main flow path, wherein the amplification flow path opens into the main flow path upstream the damping orifice.

16. The hydraulic steering arrangement according to claim 4, wherein an amplification flow path is arranged in parallel to the main flow path, wherein the amplification flow path opens into the main flow path upstream the damping orifice.

17. The hydraulic steering arrangement according to claim 5, wherein an amplification flow path is arranged in parallel to the main flow path, wherein the amplification flow path opens into the main flow path upstream the damping orifice.
